(19) United States
(12) Patent Application Publication
(10) Pub. No.: US 2012/0277082 A1
(43) Pub. Date: Nov. 1, 2012

(54) AMORPHOUS CORE MANUFACTURING METHOD AND MANUFACTURING APPARATUS

(76) Inventors: Kazutaka NISHIMURA, Tainai (JP); Junichi ISHIZUKI, Tainai (JP); Eisuke MARUYAMA, Tainai (JP); Katsuaki INOUE, Shibata (JP)

(21) Appl. No.: 13/355,017

(22) Filed: Jan. 20, 2012

(30) Foreign Application Priority Data
Apr. 26, 2011 (JP) 2011-098566

(51) Int. Cl. B26D 7/30; B65H 35/06

(52) U.S. Cl. 493/37

(57) ABSTRACT

A cutting device of the present invention includes an upper blade, an upper blade fixing plate, a lower blade and a lower blade fixing plate, the upper blade is attached by being bolt-clamped and fixed to the upper blade fixing plate from the outer side and the lower blade is attached by being bolt-clamped and fixed to the lower blade fixing plate from the outer side in a direction opposite to an upper blade attaching direction, thereby to solve problems that cutting of an amorphous sheet material is adversely affected by worn-out upper and lower blades and a time is taken to insert a spacer for adjustment of a clearance between the upper and lower blades.

### CLAIM OF PRIORITY

The present application claims priority from Japanese Patent Application JP 2011-098566, filed on Apr. 26, 2011, the content of which is hereby incorporated by reference into this application.

### BACKGROUND

1. Technical Field

The preset invention relates to amorphous core manufacturing method and manufacturing apparatus with an amorphous sheet material cutting device.

2. Description of the Related Art

In the market of transformers, it has been obliged to manufacture high efficiency transformers with introduction of the Top Runner standard of the Energy Conservation Act. Among them, a demand for amorphous core transformers is now being increased in and outside the country in order to attain remarkable energy conservation and a high efficiency by using an amorphous sheet for a core part on which an electricity conducting coil is wound. Under the above mentioned circumstance, it may be unavoidable to construct an amorphous core manufacturing line which is allowed to cope with delivery of amorphous cores of stable quality by the due date.

In an amorphous sheet cutting step which is one of steps in an amorphous core manufacturing process, several amorphous sheets are cut in a laminated state.

The amount of bite (hereinafter, referred to as a clearance) of a cutting blade constituted of upper and lower blades is very important. A too-large clearance may cause a variation in cut length or induce such a situation that laminated amorphous sheets are cut halfway and some sheets are left uncut. On the other hand, a too-small clearance may accelerate progress of wearing of the cutting blade, which may lead to frequent exchange of a worn-out blade with a new one. Therefore, it may be desirable to adjust the clearance amount to an optimum value.

If a worn-out cutting blade is detached and exchanged with a new one instead of reuse of the worn-out cutting blade for cutting, no time will be taken for adjustment of the clearance amount because the clearance amount is constant. However, since it costs too much to exchange the worn-out cutting blade with a new one each time, upper and lower blades are ground and used again. In addition, since the thickness of a cutting blade is thinned and the clearance amount is changed in accordance with a ground amount of the cutting blade, work of adjusting the clearance amount has been generated so far every time a ground cutting blade is used again.

Japanese Utility Model Application Laid-Open No. Sho 58(1983)-47425 discloses to provide a scrap cutter with no change of a clearance between blades regardless of grinding of a cutting blade because upper and lower blades are attached as cutting faces. However, it is thought that nothing is disclosed therein with regard to a configuration of the present invention.

Japanese Patent Application Laid-Open No. Hei9(1997)-201717 describes an amorphous sheet material cutting device used in manufacture of an amorphous core. However, it is thought that nothing is disclosed therein with regard to a method of attaching upper and lower blades considering a clearance between them of the present invention.

### SUMMARY

A problem to be solved lies in a clearance between upper and lower blades when used in a step of cutting an amorphous sheet material which is one of steps in an amorphous core manufacturing process as mentioned above.

One object of the present invention is to provide an attaching method by which an initial clearance between upper and lower blades is maintained even after the upper and lower blades have been ground many times and thinned.

Another object of the present invention is to provide cutting method and device in which energy conservation is considered as compared to cutting ever performed by a press.

In order to attain the above mentioned objects, according to one embodiment of the invention, an amorphous core manufacturing apparatus includes a reel on which a plurality of amorphous sheet materials are wound, a sheet separating device that unifies the amorphous sheet materials drawn out from a plurality of reels into one amorphous sheet material and separates the unified amorphous sheet material into respective sheet materials, a cutting device that again unifies the amorphous sheet materials passed through the sheet separating device into one amorphous sheet material and cuts the unified amorphous sheet material into sections of predetermined lengths and a measuring device that laminates the amorphous sheet material sections cut by the cutting device by the number corresponding to one core and measures weight of the laminated sheet material sections, wherein the amorphous sheet material cutting device includes an upper blade, a lower blade, an upper blade fixing plate for fixing the upper blade and a lower blade fixing plate for fixing the lower blade as a cutting blade, the upper blade is attached by being bolt-clamped and fixed to the upper blade fixing plate from the outer side and the lower blade is attached by being bolt-clamped and fixed to the lower blade fixing plate from the outer side in a direction opposite to a direction in which the upper blade is attached.

In the cutting device of the amorphous core manufacturing apparatus, the upper blade is attached to the upper blade fixing plate in an inclined state.

According to another embodiment of the present invention, an amorphous core manufacturing method includes a reel on which a plurality of amorphous sheet materials are wound, a sheet separating device that unifies the amorphous sheet materials drawn out from a plurality of reels into one amorphous sheet material and separates the unified amorphous sheet material into respective sheet materials, a cutting device that again unifies the amorphous sheet materials passed through the sheet separating device into one amorphous sheet material and cuts the unified amorphous sheet material into sections of predetermined lengths and a measuring device that laminates the amorphous sheet material sections cut by the cutting device by the number corresponding to one core and measures weight of the laminated sheet material sections, wherein the amorphous sheet material cutting device includes an upper blade, a lower blade, an upper blade fixing plate for fixing the upper blade and a lower blade fixing plate for fixing the lower blade as a cutting blade, the upper blade is attached by being bolt-clamped and fixed to the upper blade fixing plate from the outer side, the lower blade is attached by being bolt-clamped and fixed to the lower blade fixing plate from the outer side in a direction opposite to a direction in which the upper blade is attached and the unified amorphous sheet material is inserted between the upper and lower blades and the upper blade is lowered to cut the unified amorphous sheet material starting from a point where it touches the unified amorphous sheet material.

According to the present invention, clearance adjustment ever performed when a worn-out cutting blade is ground and reused may be eliminated and hence a total time taken for setting the ground cutting blade and for exchanging a worn-out cutting blade with a new one may be reduced owing to provision of the above mentioned configuration. As a result, a time for which an amorphous core manufacturing line is stopped may be reduced to increase productivity.

In addition, cutting which has been ever performed by a press is performed by a motor and hence energy may be conserved.

### BRIEF DESCRIPTION OF THE DRAWINGS

FIG. 1 is a diagram illustrating a part of an amorphous core manufacturing apparatus with a cutting device according to the present invention;

FIG. 2A is a front view illustrating an amorphous sheet material fixing mechanism, a sheet material feeding-out mechanism and a sheet material cutting device according to the present invention;

FIG. 2B is a side view illustrating the amorphous sheet material fixing mechanism, the sheet material feeding-out mechanism and the sheet material cutting device according to the present invention;

FIG. 3 is a front view of the cutting device according to the present invention, illustrating a state that a unified amorphous sheet material is being cut;

FIG. 4 is a perspective view illustrating an appearance of the cutting device according to the present invention;

FIG. 5 is a perspective view illustrating a state that a die set has been drawn out when a cutting blade is to be exchanged in the cutting device according to the present invention;

FIG. 6 is a perspective view illustrating a state that upper and lower blades according to the present invention are respectively attached to upper blade fixing plate and lower blade fixing plate;

FIG. 7 is a partial perspective view illustrating attachment of upper and lower blades of related art;

FIG. 8 is a partial perspective view illustrating attachment of upper and lower blades according to the present invention;

FIG. 9 is a partial sectional diagram illustrating a state that a cutting blade which is thinned by grinding again and again the upper and lower blades according to the present invention is attached;

FIG. 10A is a side view of a part in the vicinity of a cutting blade, illustrating a state that a sheet material cutting step of the present invention is not yet performed;

FIG. 10B is a side view of the part in the vicinity of the cutting blade, illustrating a state that the sheet material cutting step of the present invention is being performed; and

FIG. 10C is a side view of the part in the vicinity of the cutting blade, illustrating a state that the sheet material cutting step of the present invention has been performed.

### DETAILED DESCRIPTION OF THE PREFERRED EMBODIMENT

Hereinafter, embodiments of the present invention will be described with reference to the accompanying drawings.

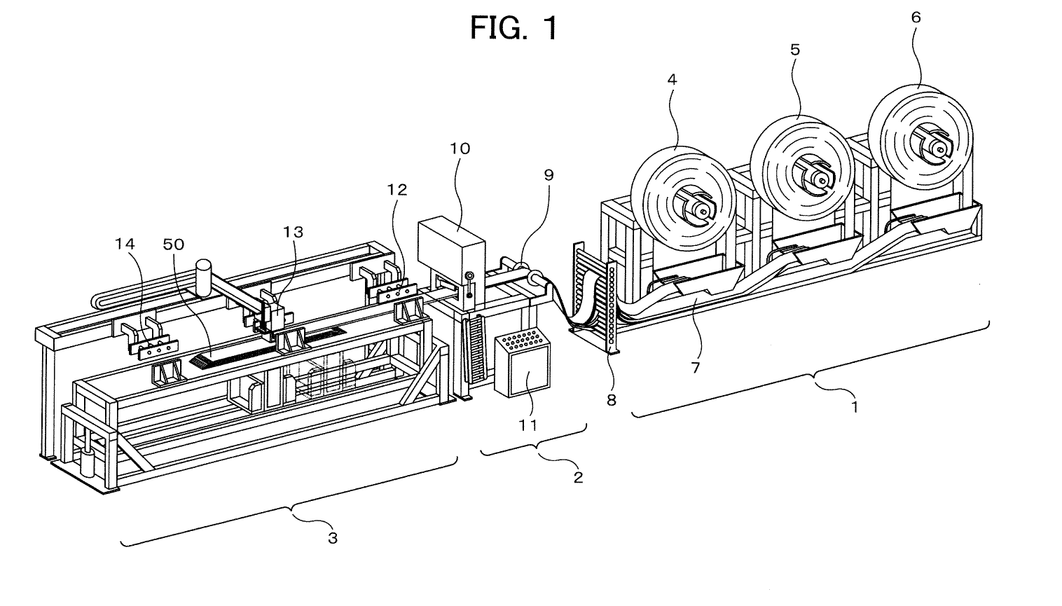

FIG. 1 illustrates devices involving amorphous sheet material cutting and measuring steps which are disposed at the front stage of an amorphous core manufacturing apparatus.

In FIG. 1, 1 is an uncoiler device having a three-train and one-stage structure that rolled amorphous sheet materials 7 which are respectively set on reels 4, 5 and 6 are rotated and drawn out, and a five-ply amorphous sheet material is wound on each reel, the sheet materials 7 wound on these reels are unified into a fifteen (15)-ply sheet material. Here, ten to twenty sheets are preferable as the number of sheets to be piled up. Too few sheets may cause reductions in machining and working efficiencies and too many sheets may cause difficulty in cutting them and may cause increases in size and cost of equipment for the uncoiler device.

The uncoiler device investigates characteristics of the amorphous sheets wound on the reels and determines arrangement of the reels having different characteristics so as to increase loss characteristics of the entire core. For example, a material which is relatively high in loss characteristics is arranged on an inner side of the core and a material which is relatively low in loss characteristics is arranged on an outer side of the core.

The 15-ply amorphous sheet material is made to pass through a separating device 8 for separating it into respective sheets. The separating device 8 includes a plurality of vertically arrayed rollers. The piled-up amorphous sheet materials are fed to and nipped between the rollers one by one to be separated from one another. It may become easy to align the amorphous sheet materials with one another when they are to be aligned in a width direction by separating the amorphous sheet materials from one another as mentioned above. Although the separating device 8 is disposed behind the uncoiler device in an example in FIG. 1, the position where the separating device 8 is to be disposed is not limited to the above and the separating device 8 may be disposed behind a cutting device.

The amorphous sheet materials 7 which have passed through the separating device 8 one by one are fed to a cutting device in which, then, the amorphous sheet materials are unified again.

2 is an integrated cutting device having functions of pressing, feeding out and cutting the unified amorphous sheet material, 10 is a cutting device, and 11 is a control device for controlling rotation of the reels of the uncoiler device 1, the amount of the unified amorphous sheet material to be fed to the cutting device, the operation of a motor used for cutting the unified amorphous sheet material into sections and a timing at which each amorphous sheet material section so cut is pulled by a clamp cylinder.

Each sheet material section cut by the cutting device 10 of the integrated cutting device 2 is then sent to a sheet material measuring unit 3. The sheet material sections of the number corresponding to one core of an amorphous transformer are piled up and the sheet material measuring unit 3 measures weight thereof.

In the sheet material measuring unit 3, 12 and 14 are aligning devices for vertically pushing amorphous sheet materials which may not be aligned with one another against them from both sides to align the materials with one another when cut and the aligning devices are disposed at three positions.

13 is a clamp cylinder configured to operate interlocking with a support which moves on a rail which is longitudinally disposed behind a place where the sheet materials are arranged. The support which moves and operates on the rail is driven by a linear motor or the like.

In the sheet material measuring unit 3, when a section cut out of the amorphous sheet material 7 is to be put on a sheet material laminate 50 by pulling it by the clamp cylinder 13, a table is lowered to put the section cut out of the amorphous sheet material 7 on the sheet material laminate 50.

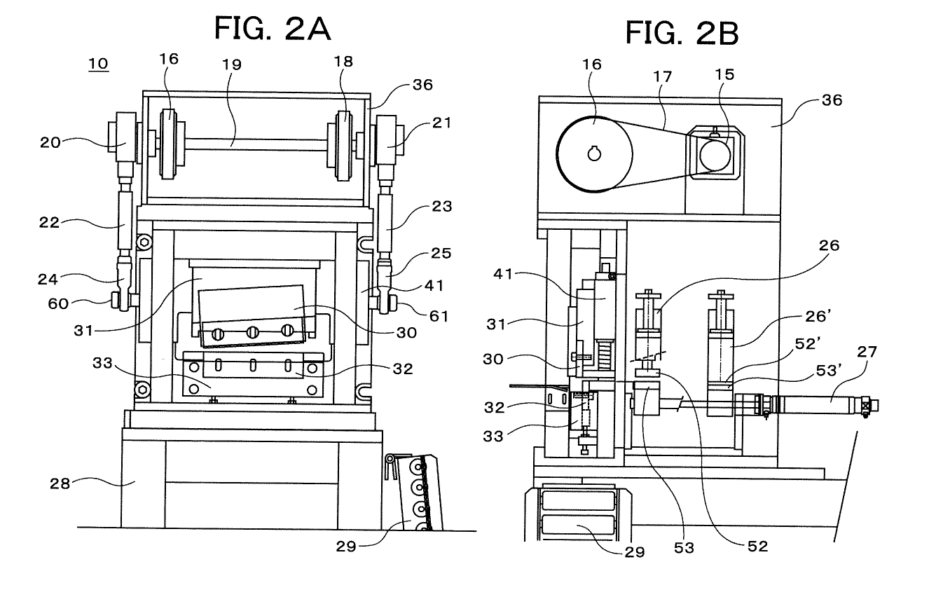

FIG. 2A and FIG. 2B illustrate the cutting device 10. FIG. 2A is a front view of the cutting device and FIG. 2B is a side view thereof.

In FIG. 2A and FIG. 2B, the cutting device 10 has a mechanism that an upper blade of a cutting blade is obliquely disposed, a lower blade thereof is horizontally disposed and fixed, a rotational motion is converted to a linear motion to vertically drive the upper blade from the both sides by one motor.

36 is a fixing plate to which a drive system such as a motor is disposed and fixed, 15 is a servo motor fixed to the fixing plate 36, 17 is a belt, 16 is a pulley around which the belt 17 is put to transmit rotational driving of the motor 15, and 18 is a pulley disposed in opposition to the pulley 16. These two pulleys 16 and 18 are coupled by a shaft 19 to rotate in cooperation with each other.

20 and 21 are eccentric cams that eccentrically rotate a rotor.

When the eccentric cams 20 and 21 rotate, coupling rods 22 and 23 are vertically driven simultaneously. The eccentric cams 20 and 21 on the both sides are disposed in the same manner so as to vertically drive the coupling rods 22 and 23 in the same manner. Coupling rings 24 and 25 are respectively connected to the coupling rods 22 and 23. An upper blade 30 is fixed to an upper blade fixing plate 31 and the upper blade fixing plate 31 is fixed to a movable base 41 which is made movable. The coupling rings 24 and 25 are engaged with protruded shafts 60 and 61 protruding from central parts of right and left ends of the movable base 41. Owing to the above mentioned configuration, when the coupling rods 22 and 23 vertically move, the movable base 41 vertically moves to vertically drive the upper blade fixing plate 31 and the upper blade 30.

Here, the upper blade 30 is obliquely disposed and fixed such that its left side is lowered as illustrated in FIG. 2A. The upper blade 30 may be inclined in an opposite direction and the same effect as the above may be obtained.

A lower blade 32 is horizontally disposed below the upper blade 30 and is fixed to a lower blade fixing plate 33. Then, the above mentioned rotational drive system and the cutting blade are disposed on a base 28.

Owing to a configuration of the cutting blade as described above, the unified amorphous sheet material 7 is cut into sections starting from a position where the upper blade 30 touches it and cutting is completed when the upper 30 has entirely reached the lower blade 32. That is, this cutting method is the same as cutting with scissors in principle. The material is cut from one side by this cutting method unlike cutting performed by exerting a high pressure on the entire blade by a press or the like and hence cutting energy may be reduced and energy may be conserved.

In FIG. 2B, 26 is s pressing mechanism part for pressing the unified amorphous sheet material 7. The pressing mechanism part 26 is configured to be moved from the side of the uncoiler device to the side of the cutting device by a sheet material feed-out mechanism part 27. FIG. 2B illustrates a state that the sheet material pressing mechanism part has been moved from a position where the sheet material pressing mechanism part is designated by 26′ to a position where the sheet material pressing mechanism part is designated by 26 on the side of the cutting device by the sheet material feed-out mechanism part 27.

In an example, the pressing mechanism part 26 for pressing the unified amorphous sheet material, the sheet material feed-out mechanism part 27 and the sheet material cutting device are integrated to form the cutting device 10.

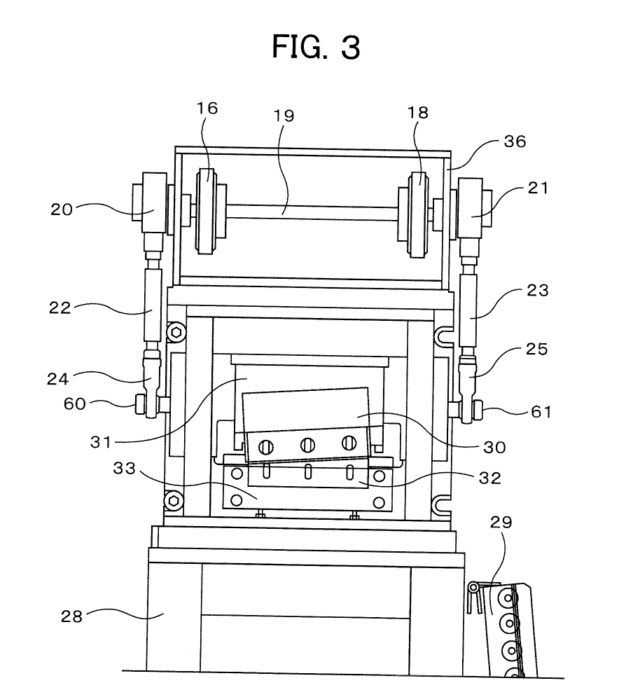

Next, FIG. 3 illustrates a state that the sheet material 7 is being cut.

FIG. 3 is a diagram illustrating a state that the upper blade 30 is partially superposed on the lower blade 32 and is cutting the unified amorphous sheet material 7.

Since the upper blade 30 is obliquely disposed and fixed as described above, the unified amorphous sheet material 7 is cut starting from a point where the upper blade 30 touches the unified sheet material 7, that is, from one side and cutting is completed when the upper blade 30 has been entirely superposed on the lower blade 32. Then, the upper blade 30 is pulled upward.

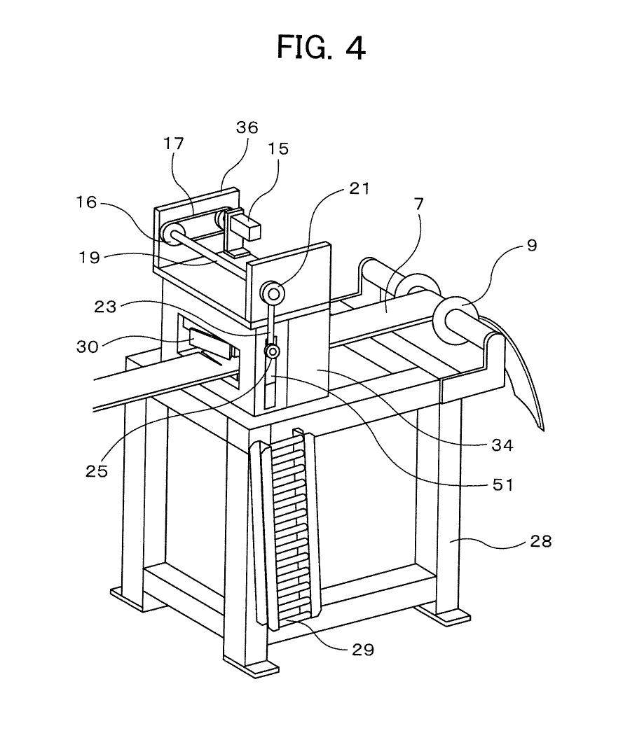

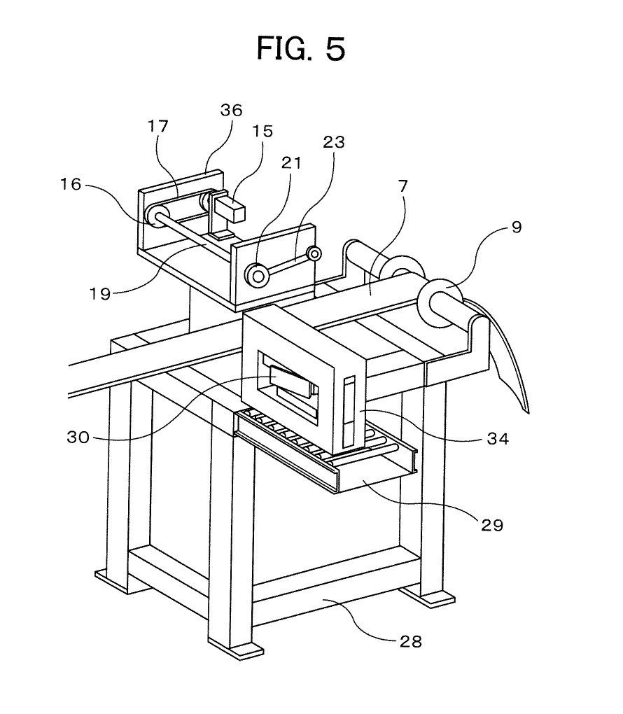

Next, exchange of a cutting blade will be described with reference to perspective views illustrating an appearance of the cutting device 10 in FIG. 4 and FIG. 5.

In FIG. 4, the cutting device 10 is disposed on the base 28, and the amorphous sheet material 7 is conveyed on a roller 9 disposed on an upper end part of the base 28 and is horizontally fed to the cutting device. A rotational system including the motor 15, the rotating pulley 16 and the eccentric cam 21 is fixed to a fixing plate 36. A die set 34 is disposed under the fixing plate 36 and the cutting blade including the upper blade 30, the upper blade fixing plate 31, the lower blade 32 and the lower blade fixing plate 33 is disposed in the die set 34. In FIG. 4, the coupling rings 24 and 25 are respectively connected to the coupling rods 22 and 23, the coupling rings 24 and 25 respectively are engaged with the protruded shafts 60 and 61 such that the protruded shaft 61 vertically moves in a linear hole 51. A notch is made in the unified sheet material 7 below the upper blade 30 in FIG. 4 for ready understanding of a state that cutting is being performed by lifting upward the upper blade 30.

FIG. 5 illustrates a state that the cutting blade for cutting the unified sheet material 7 is about to be exchanged with a new one. In exchanging the cutting blade, the fixing plate 36 on which the rotational system disposed on the die set 34 is fixed is isolated from the die set 34, a roller conveyer 29 is assembled to be horizontally disposed above the base 28, the die set 34 containing the cutting blade is made to slide on the roller conveyer 29 so as to attain an easy-to-work state. In isolating the die set 34 from the fixing plate 36, the coupling rings 24 and 25 attached to the leading ends of the coupling rods 22 and 23 are disengaged from the protruded shafts 60 and 61.

The die set 34 is configured to be also isolated from the sheet material pressing mechanism part 26 and the sheet material feed-out mechanism part 27.

The die set 34 is pulled out, a case that covers the entire die set 34 is removed from the die set 34 and the bolts are unclamped from the upper and lower blades of the cutting blade to exchange the cutting blade with a new one.

After cutting blade exchange has been completed, the cutting blade is covered with the case of the die set. After covering of the cutting blade has been completed, the cutting blade is set by returning it to a part below the fixing plate 35 of the motor, detaching the roller conveyer 29 from the base 28 and fitting the coupling rings 24 and 25 disposed on the leading ends of the coupling rods 22 and 23 on the protruded shafts 60 and 61.

Although the unified sheet material 7 is illustrated in FIG. 5, the die set 34 is isolated from the fixing plate 36 and is returned to its original position in a state that the unified sheet material 7 is removed.

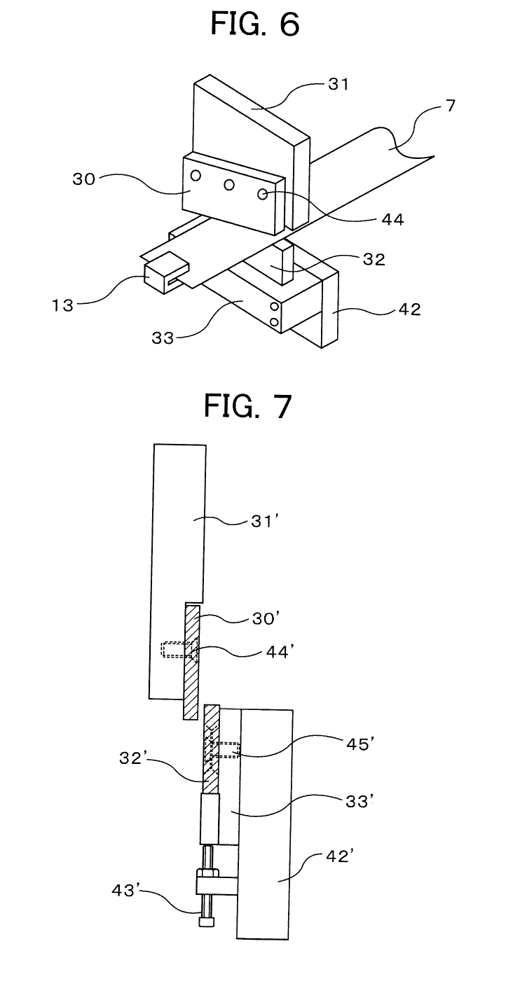

Next, the cutting blade will be described with reference to FIG. 6 to FIG. 9.

FIG. 6 is a partial perspective view illustrating a partial appearance of the cutting blade.

In FIG. 6, the unified sheet material 7 is made to pass between the upper blade 30 and the lower blade 31. The unified sheet material 7 is pulled in a state that it is nipped by the clamp cylinder 13, is stopped when a designated cut length is attained and is cut into a section of the designated cut length.

The sheet materials 7 are supplied from the three-train and one-stage uncoiler device. Since the number of sheet materials wound on each reel is five, the number of sheet materials to be cut is fifteen in total.

The upper blade 30 is obliquely disposed and fixed to the upper blade fixing plate 31 with a bolt 44 from the outer side.

The lower blade 32 is horizontally fixed to the lower blade fixing plate 33 with a bolt 45. The lower blade fixing plate 33 has an inverted square-C-shaped part. The lower blade 32 is fixed to the inside of the inverted square-C-shaped part in a direction opposite to a fixing direction of the upper blade 30 from the outer side. Then, the lower blade fixing plate 33 is fixed to a fixing base 42.

Even though the total number of amorphous sheet materials which are unified is fifteen, the upper blade 30 and the lower blade 32 may be worn out when cutting is repeatedly performed. A worn-out blade is detached from the fixing plate, is ground and is again attached to the fixing plate to be used. The thickness of the cutting blade itself is gradually thinned as the cutting blade is repeatedly ground and used. Therefore, a problem of clearance may occur when a thinned cutting blade is attached.

In FIG. 6, since the upper and lower blades included in the cutting blade are made of cemented carbide and are rectangular parallelepipeds, parts used as blades are four long sides of each rectangular parallelepiped. Thus, the manufacturing cost may be more reduced by using up the four sides of each blade and then grinding each blade to be used before each blade is detached from each fixing plate and is ground to be used.

FIG. 7 illustrates a cutting blade attaching method of related art.

In FIG. 7, 30′ is an upper blade and 31′ is an upper blade fixing plate, the upper blade 30′ is fixed to the upper blade fixing plate 31′ with a bolt 44′ from the inner side, 32′ is a lower blade and 33′ is a lower blade fixing plate, the lower blade 32′ is fixed to the lower blade fixing plate 32′ with a bolt 45′ from the inner side. That is, the upper blade 30′ and the lower blade 32′ are respectively fixed to the fixing plates 31′ and 33′ from the inner sides.

43′ is an adjusting screw for adjusting a vertical position of the lower blade 32′.

In the cutting blade attaching method of related art illustrated in FIG. 7, there is a tendency that a clearance between the upper and lower blades is gradually increased after disposed as the upper blade and lower blades are ground again and again and the thinned upper and lower blades are used. Thus, sharpness in cutting sheet materials is gradually reduced.

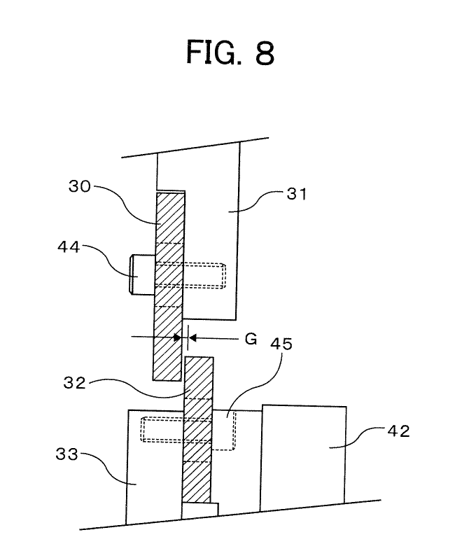

FIG. 8 illustrates a cutting blade attaching method of the present invention.

A notch into which the upper blade 30 fits is formed in the upper blade fixing plate 30 and the upper blade 30 is brought into abutment against the notch and fixed to the fixing plate 31 with the bolt 44 from the outer side. The lower blade 32 is fixed to the lower blade fixing plate 33 with the bolt 45 from the outer side in a direction opposite to a direction in which the upper blade 30 is attached. The lower blade fixing plate 33 has an inverted square-C-shaped part and is fixed to the fixing base 42 in a state that the lower blade 32 is fixed into the inverted square-C-shaped part. A clearance G between the upper and lower blades may be set to a predetermined value optimum for cutting by the method of attaching the upper blade 30 and the lower blade 32 of the present invention.

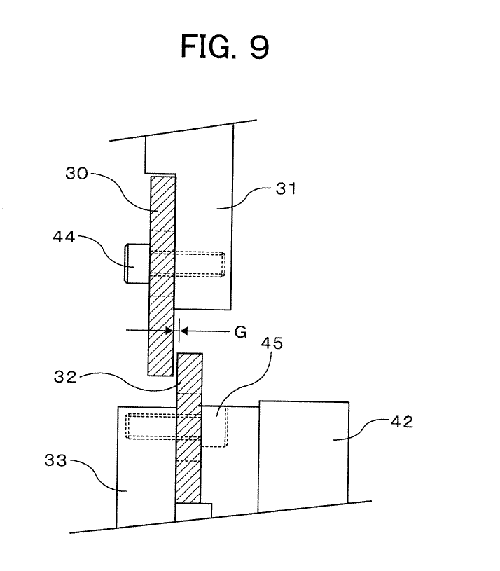

Next, an attaching method performed when the upper blade 30 and the lower blade 32 included in the cutting blade are ground and thinned will be described with reference to FIG. 9.

FIG. 9 illustrates a configuration which is the same as that in FIG. 8 except that attachment performed when the thicknesses of the upper blade 30 and the lower blade 32 have been reduced is illustrated. The upper blade 30 is fixed into the notch in the upper blade fixing plate 31 with the bolt 44 from the outer side with the blade directed downward as in the case in FIG. 8. The lower blade 32 is fixed into the inverted square-C-shaped part with the bolt 45 in the direction opposite to the attaching direction of the upper blade with the blade directed upward.

Since the upper blade 30 and the lower blade 32 are ground again and again, these blades are thinner than original blades obtained before ground. When the upper blade 30 and the lower blade 32 which are reduced in thickness are attached and fixed, the clearance G between the upper blade 30 and the lower blade 32 may become the same as that illustrated in FIG. 8, that is, may have a configuration which is the same as that obtained before ground. That is, such an effect may be obtained that the clearance is not changed regardless of use of the ground upper and lower blades 30 and 32.

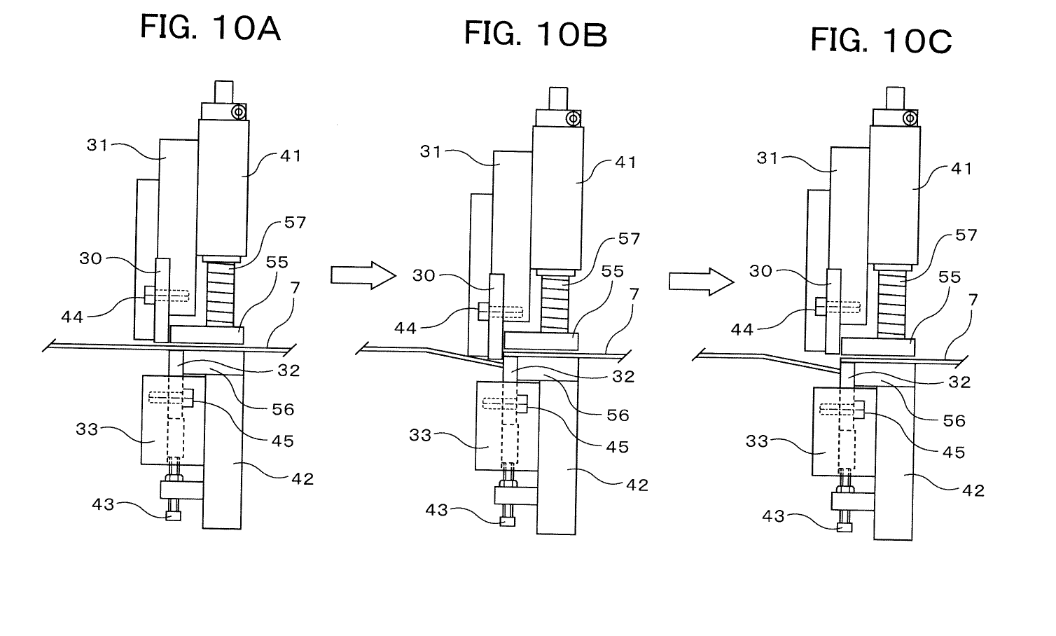

FIG. 10A, FIG. 10B and FIG. 10C are diagrams of a part in the vicinity of a cutting blade, illustrating a process along which the unified amorphous sheet material 7 is gradually cut by the cutting blade. FIG. 10A illustrates a state that the unified amorphous sheet material is not yet cut, FIG. 10B illustrates a state that the unified amorphous sheet material is being cut, and FIG. 10C illustrates a state that cutting is completed.

In FIG. 10A, the upper blade 30 is fixed into the notch in the upper blade fixing plate 31 with the bolt 44 from the outer side. The upper blade fixing plate 31 is fixed to the movable base 41. A pressing plate 55 for pressing the unified amorphous sheet material 7 via a shaft 57 is disposed below the movable base 41. A compression spring is disposed around the shaft 57.

The lower blade 32 is fixed to the lower blade fixing plate 33 with the bolt 45 from the outer side in a direction opposite to a fixing direction of the upper blade 30. The lower blade fixing plate 33 is fixed to the fixing base 44 and a sheet material receiving plate 56 is disposed on the fixing base 42 at a position in opposition to the pressing plate 55 of the movable base 41.

An adjusting screw 43 is allowed to adjust the lower blade 32 to be moved vertically.

In the cutting device so configured, when a predetermined cut length is determined, the clamp cylinder 13 stops pulling the unified amorphous sheet material. Then, the servo motor 15 rotates, a rotational motion of the motor is converted to a vertically working linear motion by an eccentric cam, and the movable base 41 drives the unified amorphous sheet materials 7 in a pressing direction to nip the unified amorphous sheet material between the sheet material pressing plate 55 and the sheet material receiving plate 56 to fix it.

FIG. 10B is a diagram illustrating a state that the upper blade 30 is lowered and is cutting the unified amorphous sheet material 7 which is fixed by being nipped between the sheet material pressing plate 55 and the sheet material receiving plate 56. Since the upper blade 30 is attached in an inclined state, the upper blade 30 is totally lowered toward the lower blade 32 to complete cutting of the unified amorphous sheet material 7.

FIG. 10C illustrates a state that cutting of the unified amorphous sheet material 7 is completed, the movable base 47 moves upward, the upper blade 30 and the sheet material pressing plate 55 move upward simultaneously, and the unified amorphous sheet material 7 has been released from a fixed state. The unified amorphous sheet material which has been cut into a section of a predetermined length in this state is nip-held by the clam cylinder 13 and is pulled to the sheet material measuring device to be laminated on the sheet material laminate 50 in FIG. 1.

What is claimed is:

1. An amorphous core manufacturing apparatus, comprising:
a reel on which a plurality of amorphous sheet materials are wound;
a sheet separating device that unifies the amorphous sheet materials drawn out from a plurality of reels into one amorphous sheet material and separates the unified amorphous sheet material into respective sheet materials;
a cutting device that again unifies the amorphous sheet materials passed through the sheet separating device into one amorphous sheet material and cuts the unified amorphous sheet material into sections of predetermined lengths; and
a measuring device that laminates the amorphous sheet material sections cut by the cutting device by the number corresponding to one core and measures weight of the laminated sheet material sections,
wherein the amorphous sheet material cutting device includes,
an upper blade, a lower blade, an upper blade fixing plate for fixing the upper blade and a lower blade fixing plate for fixing the lower blade as a cutting blade,
the upper blade is attached by being bolt-clamped and fixed to the upper blade fixing plate from the outer side, and
the lower blade is attached by being bolt-clamped and fixed to the lower blade fixing plate from the outer side in a direction opposite to a direction in which the upper blade is attached.

2. The amorphous core manufacturing apparatus according to claim 1, wherein
in the cutting device, the upper blade is attached to the upper blade fixing plate in an inclined state.

3. An amorphous core manufacturing method, comprising:
a reel on which a plurality of amorphous sheet materials are wound;
a sheet separating device that unifies the amorphous sheet materials drawn out from a plurality of reels into one amorphous sheet material and separates the unified amorphous sheet material into respective sheet materials;
a cutting device that again unifies the amorphous sheet materials passed through the sheet separating device into one amorphous sheet material and cuts the unified amorphous sheet material into sections of predetermined lengths; and
a measuring device that laminates the amorphous sheet material sections cut by the cutting device by the number corresponding to one core and measures weight of the laminated sheet material sections,
wherein the amorphous sheet material cutting device includes,
an upper blade, a lower blade, an upper blade fixing plate for fixing the upper blade and a lower blade fixing plate for fixing the lower blade as a cutting blade,
the upper blade is attached by being bolt-clamped and fixed to the upper blade fixing plate from the outer side,
the lower blade is attached by being bolt-clamped and fixed to the lower blade fixing plate from the outer side in a direction opposite to a direction in which the upper blade is attached, and
the unified amorphous sheet material is inserted between the upper and lower blades and the upper blade is lowered to cut the unified amorphous sheet material starting from a point where it touches the unified amorphous sheet material.
